(19) United States
(12) Patent Application Publication
(10) Pub. No.: US 2026/0307457 A1
(43) Pub. Date: Oct. 8, 2026

(54) PERFORMANCE ENHANCEMENT OF HVAC SYSTEM THERMALLY CONDITIONED BY MULTIPLE BRANCH COOLING SUBSYSTEM

(71) Applicant: GM GLOBAL TECHNOLOGY OPERATIONS LLC, Detroit, MI (US)

(72) Inventors: Benjamin C. Groen, Troy, MI (US); Justin A. Bunnell, Cary, NC (US); Philip J. Prociw, Clinton Township, MI (US); Andres V. Mituta, Lake Orion, MI (US)

(73) Assignee: GM GLOBAL TECHNOLOGY OPERATIONS LLC, Detroit, MI (US)

(21) Appl. No.: 19/172,734

(22) Filed: Apr. 8, 2025

(51) Int. Cl. B60H 1/00

(52) U.S. Cl. CPC B60H 1/00885; B60H 1/00278; B60H 1/00485; B60H 1/00807

(57) ABSTRACT

A system for enhancing performance of a heating, air conditioning, and ventilation (HVAC) system includes high thermal mass rechargeable energy storage system (RESS) modules, a low thermal mass auxiliary module(s), and a cooling subsystem having a main coolant loop with a coolant thermal conditioning device. The HVAC and individual parallel RESS coolant branches in parallel with auxiliary coolant branch(s) are connected to the main coolant loop. An electronic controller determines temperatures of the RESS module(s) and the auxiliary module(s) relative to respective temperature ranges, conditions coolant in the main loop, and restricts coolant flow therefrom into RESS coolant branch(s) when temperature of RESS module(s) is inside a first temperature range. The controller also regulates coolant flow from the main loop into the auxiliary branch when auxiliary module temperature is outside a second temperature range to provide the target temperature coolant from the main coolant loop to the HVAC.

### INTRODUCTION

The present disclosure relates to prioritizing, enhancing, and optimizing performance of a heating, air conditioning, and ventilation (HVAC) system thermally conditioned by a multiple branch cooling subsystem, such as used for a multi-cell rechargeable energy storage system (RESS).

Typically, an electric energy generation and storage battery system includes one or more battery cells for powering a load. A plurality of battery cells may be arranged in close proximity to one another to generate a battery module and a plurality of battery modules may be organized into a battery pack array. Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental, and ease-of-use benefits compared to disposable batteries.

Rechargeable batteries may be used to power such diverse items as toys, consumer electronics, and motor vehicles. Particular chemistries of rechargeable batteries, such as lithium-ion cells, as well as external factors, may cause internal reaction rates generating significant amounts of thermal energy. Exposure of a battery cell to elevated temperatures over prolonged periods may cause the cell to experience a thermal runaway event, where heat build-up in an individual cell leads to the heat spreading to adjacent cells in the module and affecting the entire battery array. Additionally, temperature extremes may affect battery cell power generation. Accordingly, thermal energy needs to be effectively managed to optimize battery system performance. Generally, devices such as heat-sinks or cold-plates with circulating coolant are employed to remove heat from battery systems.

### SUMMARY

A system for enhancing performance of a heating, air conditioning, and ventilation (HVAC) system includes a multi-cell rechargeable energy storage system (RESS) having a plurality of relatively high thermal mass RESS modules. The system also includes an auxiliary module having a relatively low thermal mass and a cooling subsystem including a main coolant loop fluidly connected to the HVAC system and configured to circulate coolant. The cooling subsystem additionally includes at least one coolant thermal conditioning device arranged in the main coolant loop. The cooling subsystem also includes a plurality of RESS coolant branches arranged in parallel, wherein each RESS coolant branch is configured to receive coolant from the main coolant loop to adjust temperature of one of the respective RESS modules. The cooling subsystem additionally includes an auxiliary coolant branch arranged in parallel with the plurality of RESS coolant branches and configured to receive coolant from the main coolant loop to adjust temperature of the auxiliary module.

The system also includes an electronic controller in operative communication with the cooling subsystem and configured to determine when temperature of at least one of the RESS modules is inside a first predetermined temperature range. The electronic controller is additionally configured to determine when temperature of the auxiliary module is outside a second predetermined temperature range. The electronic controller is additionally configured to thermally condition the coolant in the main coolant loop to a target temperature. The electronic controller is additionally configured to restrict a flow of coolant from the main coolant loop individually into at least one of the RESS coolant branches when temperature of the corresponding at least one RESS module is inside the first predetermined temperature range. The electronic controller is additionally configured to regulate a flow of coolant from the main coolant loop into the auxiliary coolant branch when temperature of the auxiliary module is outside the second predetermined temperature range. Regulating the flow of coolant into the auxiliary coolant branch under such conditions is intended to maintain target coolant temperature in the main coolant loop and provide such coolant to the HVAC system, thereby enhancing HVAC system performance.

The flow of coolant may be regulated into the auxiliary coolant branch to additionally provide at least a predefined minimum flow rate of the coolant through the cooling subsystem for requisite performance of the HVAC system.

The relatively high thermal mass RESS modules may include individual battery modules having a plurality of battery cells.

The cooling subsystem may additionally include at least one RESS flow-valve in operative communication with the electronic controller and configured to regulate and distribute across the plurality of RESS coolant branches the coolant received from the main coolant loop.

The RESS flow-valve(s) may be configured as a multi-way valve assembly arranged in a junction between the main coolant loop and the plurality of RESS coolant branches and configured to control a flow of the coolant into each of the RESS coolant branches.

The RESS flow-valve(s) may be configured as a plurality of individual throttle valves, each throttle valve arranged in one of the plurality of RESS coolant branches upstream of the corresponding RESS module and configured to control a flow of the coolant into the subject RESS coolant branch.

Each RESS coolant branch may include a one-way valve configured to control a flow of the coolant out of the subject RESS coolant branch.

The cooling subsystem may also include a bypass flow-valve in operative communication with the electronic controller and configured to regulate the coolant in the auxiliary coolant branch.

The cooling subsystem may additionally include a one-way valve configured to control a flow of the coolant out of the auxiliary coolant branch.

The cooling subsystem may further include a fluid pump configured to circulate the coolant through the main coolant loop.

The at least one coolant thermal conditioning device may include a coolant heater configured to add thermal energy to the coolant in the main coolant loop and/or a coolant-to-air heat exchanger configured to remove thermal energy from the coolant in the main coolant loop.

A motor vehicle employing the above-described system and a method of enhancing performance of the HVAC system are also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing multiple power-sources, a heating, air conditioning, and ventilation (HVAC), multi-cell rechargeable energy storage system (RESS) having individual modules and configured to generate and store electrical energy used by vehicle systems, an auxiliary module, and a system for enhancing performance of the HVAC system, according to the disclosure.

FIG. 2 is a schematic illustration of the system for enhancing performance capabilities of the HVAC system shown in FIG. 1, including an embodiment of a cooling subsystem having a main coolant loop and multiple parallel coolant branches for adjusting temperature in individual battery modules and in the auxiliary module, according to the disclosure.

FIG. 3 is a schematic illustration of the system for enhancing performance capabilities of the HVAC system shown in FIG. 1, including another embodiment of the cooling subsystem having a main coolant loop and multiple parallel coolant branches for adjusting temperature in individual battery modules and in the auxiliary module, according to the disclosure.

FIG. 4 illustrates a method of enhancing performance of the HVAC system employing the coolant subsystem shown in FIGS. 1-3, according to the disclosure.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “top”, and “bottom”, etc., describe the orientation and/or location of portions of the components or elements within a consistent but arbitrary frame of reference, which is made clear by reference to the text and the associated drawings describing the components or elements under discussion.

Furthermore, terms such as “first”, “second”, “third”, and so on may be used to describe separate components. Such terminology may include the words specifically mentioned above, derivatives thereof, and words of similar import, and are used descriptively for the figures, and do not represent limitations on the scope of the disclosure, as defined by the appended claims. Moreover, the teachings may be described herein in terms of functional and/or logical block components and/or various processing steps. It should be realized that such block components may include a number of hardware, software, and/or firmware components configured to perform the specified functions.

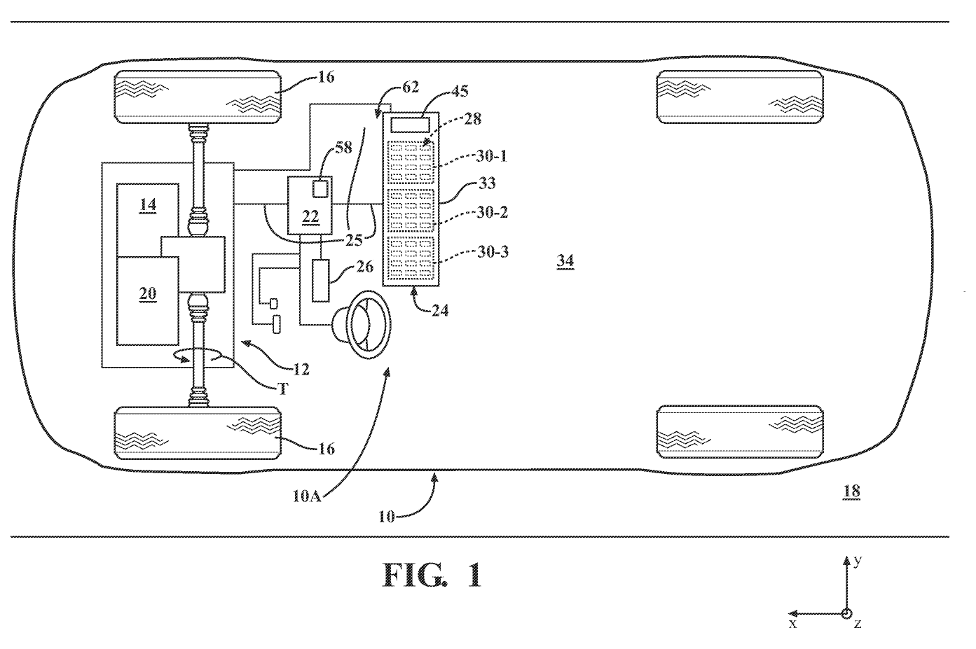

Referring to the drawings, wherein like reference numbers refer to like components, FIG. 1 shows a schematic view of a motor vehicle 10 having a vehicle operator/passenger cabin 10A and a powertrain 12. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. The powertrain 12 includes a power-source 14 configured to generate a power-source torque T (shown in FIG. 1) for propulsion of the vehicle 10 via driven wheels 16 relative to a road surface 18. The power-source 14 is depicted as an electric motor-generator.

As shown in FIG. 1, the powertrain 12 may include an additional power-source 20, such as an internal combustion engine. The power-sources 14 and 20 may act in concert to power the vehicle 10. The vehicle 10 additionally includes a central processing unit (CPU) 22 and a multi-cell rechargeable energy storage system (RESS) 24 configured to generate and store electrical energy through heat-producing electro-chemical reactions for supplying the electrical energy to the power-sources 14 and 20. The vehicle 10 also includes a high-voltage databus or BUS 25 for communicating electrical signals between various vehicle systems. The vehicle 10 further includes a vehicle heating, air conditioning, and ventilation (HVAC) system 26 configured to regulate temperature in the vehicle cabin 10A. The CPU 22 regulates various systems of the vehicle 10, including the powertrain 12 to generate a predetermined amount of power-source torque T and the HVAC 26. The RESS 24 may be connected via BUS 25 to the power-sources 14 and 20, to the electronic CPU 22, as well as to other vehicle systems, such as the HVAC 26.

As shown in FIGS. 1-3, the RESS 24 includes a plurality of battery cells 28, such as lithium-ion rechargeable cells, arranged in individual battery modules, such as a first module 30-1, a second module 30-2, and a third module 30-3. The subject modules 30-1, 30-2, 30-3 may be arranged electrically in series or in parallel. Within individual modules, e.g., 30-1, 30-2, 30-3, distinct battery cells 28 may be connected electrically in series or in parallel and assembled into cell groups. Such cell groups are then electrically connected in series and assembled into individual modules. Although three individual battery modules are specifically shown, it is intended that the RESS 24 includes at least two respective modules, and multiple modules may be organized into battery packs.

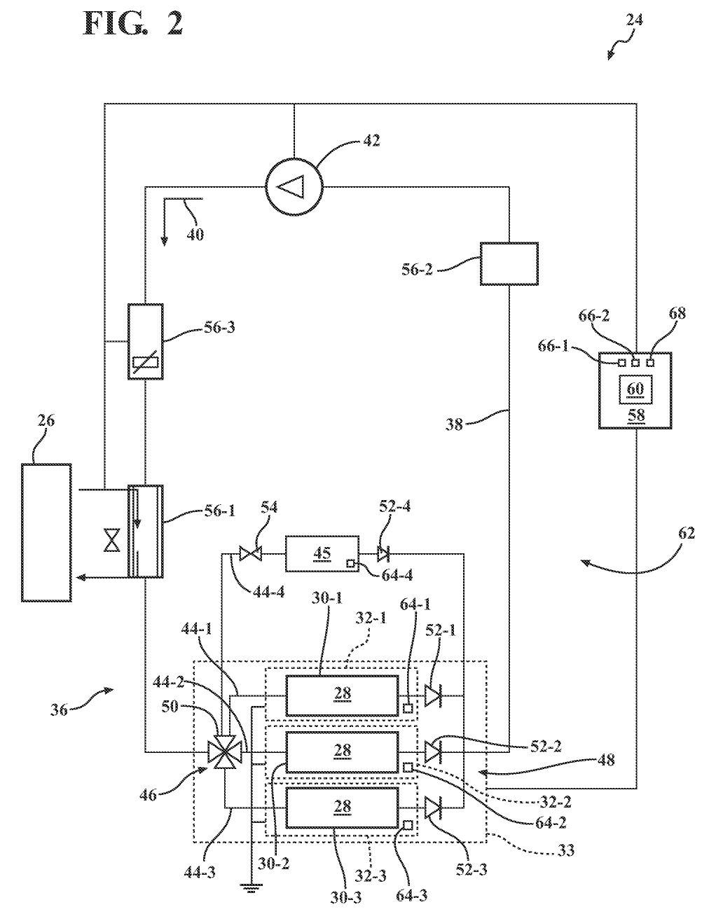

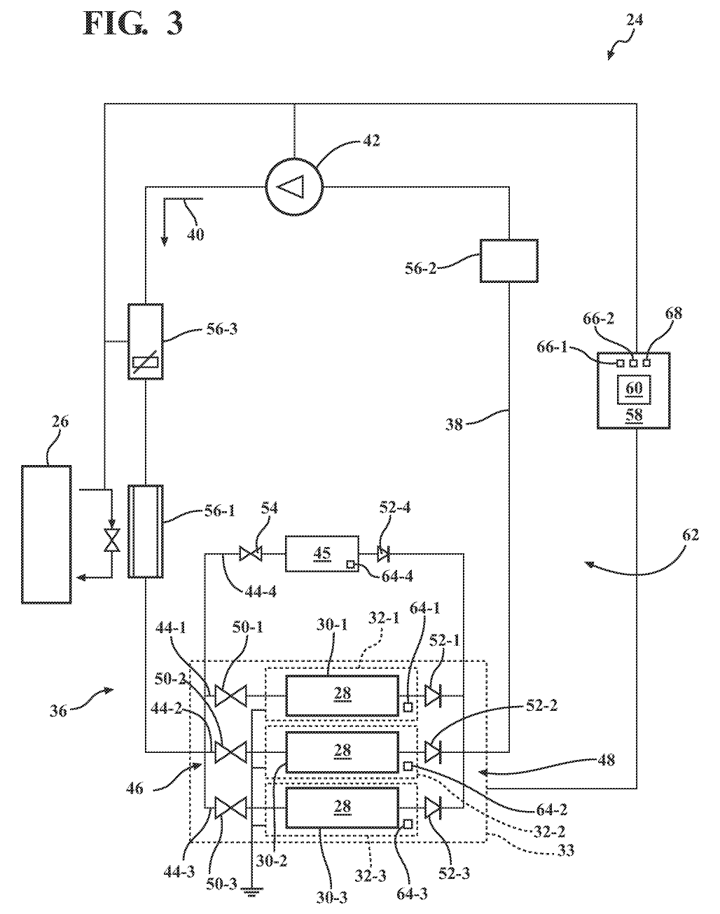

The remainder of the present description will focus on RESS 24 construction having three battery modules 30-1, 30-2, 30-3, with each battery module having a desired quantity of battery cells 28. As shown in FIGS. 2 and 3, each battery module 30-1, 30-2, 30-3 includes a respective battery module enclosure 32-1, 32-2, 32-3 connected to chassis ground and configured to house and support the corresponding battery cells 28. The RESS 24 may also include a battery pack enclosure 33 surrounded by an ambient environment 34 and configured to house and support the battery modules 30-1, 30-2, 30-3 (shown in FIG. 1).

As shown in FIGS. 2 and 3, RESS 24 also includes a cooling subsystem 36 configured to remove thermal energy from various temperature sensitive components of the RESS. Cooling subsystem 36 includes a main coolant loop 38 configured to circulate a coolant 40 through the RESS 24 and the HVAC system 26. As shown, cooling subsystem 36 also includes a fluid pump 42 configured to circulate coolant 40 through the main coolant loop 38. The cooling subsystem 36 further includes a plurality of coolant branches, shown as a first branch 44-1, a second branch 44-2, and a third branch 44-3, in fluid communication with the main coolant loop 38. Each of the coolant branches 44-1, 44-2, 44-3 extends through a respective battery module 30-1, 30-2, 30-3, proximate and along the constituent battery cells 28.

Furthermore, each coolant branch 44-1, 44-2, 44-3 is configured to receive a portion of coolant 40 from the main coolant loop 38. The coolant branches 44-1, 44-2, 44-3 are arranged fluidly in parallel to receive respective portions of the coolant 40. The coolant branches 44-1, 44-2, 44-3 are thereby configured to independently circulate their respective portions of the coolant 40 and adjust the temperature of the corresponding battery modules 30-1, 30-2, 30-3 (by removing or adding thermal energy). Accordingly, each coolant branch 44-1, 44-2, 44-3 passes through one of the battery module enclosures 32-1, 32-2, 32-3. As shown, the main coolant loop 38 is in fluid communication with one or more auxiliary coolant branches, such as branch 44-4 shown in FIGS. 2 and 3, arranged in parallel with coolant branches 44-1, 44-2, 44-3.

For example, each additional coolant branch 44-4 may be configured to receive coolant 40 from the main coolant loop 38 and circulate the coolant through an auxiliary module or device, identified generally via numeral 45. Such an auxiliary module or device may, for example, be an auxiliary power module (APM), a Battery Disconnect Unit (BDU) including various electrical switches and relays, a DC/DC converter for supplying 12V/48V power to vehicle 10, an optionally insulated coolant bypass, etc., each having particular temperature requirements and/or thermal energy absorption/dissipation characteristics. Additionally, the main coolant loop 38 is fluidly connected to the HVAC system 26 to provide thermal conditioning thereof. For example, the cooling subsystem 36 may thermally condition the HVAC system 26 via a dedicated bi-directional heat pump operating through two HVAC heat exchangers, one heat exchanger interfacing with the cabin 10A air (not shown) and the other heat exchanger, identified by numeral 56-1, interfacing with the main coolant loop 38.

Accordingly, at least some of the coolant branches 44-1, 44-2, 44-3 are configured to receive respective portions of coolant 40 from the main coolant loop 38 to adjust the temperature of corresponding individual battery modules 30-1, 30-2, 30-3. Likewise, respective branch(s) 44-4 are configured to receive portion(s) of coolant 40 from the main coolant loop 38 to adjust the temperature of corresponding auxiliary module(s) 45. Each of the battery modules 30-1, 30-2, 30-3 and individual auxiliary modules 45 may generate, transfer, and/or dissipate thermal energy. Additionally, each of the battery modules 30-1, 30-2, 30-3 and auxiliary module(s) 45 is characterized by an individual mass that is central to absorption and dissipation of thermal energy, which is herein defined as a “thermal mass”. As understood, a higher thermal mass is capable of absorbing from or dissipating to its surroundings a larger amount of thermal energy, by conduction, convection, or radiation, than a lower thermal mass. Within the context of the present disclosure, each of the battery modules 30-1, 30-2, 30-3 is defined by a relatively or comparatively high thermal mass, while each individual auxiliary module 45 is defined by a comparatively lower thermal mass.

With continued reference to FIGS. 2 and 3, the RESS 24 may also include an inlet manifold 46 configured to connect the main coolant loop 38 to the coolant branches 44-1, 44-2, 44-3 and an outlet manifold 48 configured to connect the coolant branches back to the main coolant loop. Accordingly, the inlet and outlet manifolds 46, 48 are together configured to maintain circulation of coolant 40 through the cooling subsystem 36. The cooling subsystem 36 additionally includes at least one RESS flow-valve 50. The RESS flow-valve(s) 50 are configured to regulate and distribute across the individual coolant branches 44-1, 44-2, 44-3, the coolant 40 circulated through and received from the main coolant loop 38. In other words, the RESS flow-valve(s) 50 are specifically structured and operated to provide independent regulation of coolant flow into each individual coolant branch 44-1, 44-2, 44-3.

As shown in FIG. 2, the RESS flow-valve 50 may be a multi-way valve assembly arranged in a junction, such as the inlet manifold 46, between the main coolant loop 38 and the plurality of coolant branches 44-1, 44-2, 44-3 upstream of each battery module 30-1, 30-2, 30-3. The multi-way valve assembly embodiment of the RESS flow-valve 50 may be configured to control the flow of coolant 40 into each of the coolant branches 44-1, 44-2, 44-3. As shown in FIG. 3, the RESS flow-valve(s) 50 may be a plurality of individual throttle valves 50-1, 50-2, 50-3. Each subject throttle valve 50-1, 50-2, 50-3 may be arranged in one of the plurality of coolant branches 44-1, 44-2, 44-3 upstream of the corresponding battery module 30-1, 30-2, 30-3 and configured to control the flow of the coolant 40 into the subject coolant branch.

As shown in FIGS. 2 and 3, each coolant branch 44-1, 44-2, 44-3 may include a respective one-way valve 52-1, 52-2, 52-3. The one-way valves 52-1, 52-2, 52-3 are configured to prevent backflow of the coolant 40 into the corresponding coolant branches 44-1, 44-2, 44-3. Each of the one-way valves 52-1, 52-2, 52-3 is arranged aft of the RESS flow-valve(s) 50 and downstream of the corresponding battery module 30-1, 30-2, 30-3. Accordingly, each one-way valve 52-1, 52-2, 52-3 is configured to control the flow of the corresponding portion of the coolant 40 through and out of the subject coolant branch 44-1, 44-2, 44-3.

The cooling subsystem 36 may also include a bypass flow-valve 54 configured to regulate coolant flow in the auxiliary coolant branch 44-4 received from the main coolant loop 38. Additionally, cooling subsystem 36 may include a one-way valve 52-4 configured to control a flow of the coolant 40 out of the auxiliary coolant branch 44-4. Cooling subsystem 36 may also include one or more coolant thermal conditioning devices arranged in the main coolant loop 38. Specifically, as shown in FIGS. 2 and 3, the coolant thermal conditioning devices may include a coolant-to-air heat exchanger 56-2 configured to remove thermal energy from coolant 40 in the main coolant loop 38 downstream of the RESS and auxiliary modules and/or a coolant heater 56-3 configured to add thermal energy to the main loop coolant. For example, an embodiment of the coolant-to-air heat exchanger 56-2 may reject heat to the ambient environment 34, while the coolant heater 56-3 may use electrical resistance, to correspondingly thermally condition the coolant 40. The coolant-to-air heat exchanger 56-2 may be placed directly in line with the main coolant loop 38, or, although not shown, may be thermally connected to the main coolant loop through a coolant-to-coolant heat exchanger or a valve body assembly for mixing coolant through a separate coolant loop.

As shown in FIGS. 1-3, the multi-cell RESS 24 may additionally include an electronic controller 58 that may be either electronically connected to or be part of the CPU 22. The electronic controller 58 is in operative communication with the cooling subsystem 36, i.e., configured or programmed to regulate operation of the cooling subsystem, and may be structured to manage operation of the RESS 24, as well as the auxiliary module 45. As shown, the electronic controller 58 is in operative communication with the fluid pump 42, the RESS flow-valve(s) 50, the bypass flow-valve 54, the HVAC heat exchanger 56-1, and the coolant heater 56-3. To support requisite management of the RESS 24 and/or the cooling subsystem 36, the electronic controller 58 specifically includes a processor and tangible, non-transitory memory, which includes requisite instructions programmed therein. The controller’s memory may be an appropriate recordable medium that participates in providing computer-readable data or process instructions. Such a recordable medium may take many forms, including but not limited to non-volatile media and volatile media.

Non-volatile media for electronic controller 58 may include, for example, optical or magnetic disks and other persistent memory. Volatile media may include, for example, dynamic random-access memory (DRAM), which may constitute a main memory. The instructions programmed into the controller 58 may be transmitted by one or more transmission medium, including coaxial cables, copper wire and fiber optics, including the wires that comprise a system bus coupled to a processor of a computer, or via a wireless connection. Memory of the electronic controller 58 may also include a flexible disk, hard disk, magnetic tape, another magnetic medium, a CD-ROM, DVD, another optical medium, etc. The electronic controller 58 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry.

The electronic controller 58 may be configured to regulate the flow of coolant 40 into the individual battery modules 30-1, 30-2, 30-3 through the corresponding coolant branches 44-1, 44-2, 44-3 via the fluid pump 42 and the RESS flow-valve(s) 50. Similarly, electronic controller 58 may be configured to regulate the flow of coolant 40 from the main coolant loop 38 into the auxiliary module 45 through the coolant branch 44-4. Algorithm(s), indicated generally via numeral 60, required by the electronic controller 58 or accessible thereby may be stored in the memory of the controller and automatically executed to facilitate operation of the RESS 24 and/or the cooling subsystem 36. Function of the cooling subsystem 36 may be regulated by the electronic controller 58 under normal operating conditions as well as for the purpose of enhancing (or optimizing) performance capabilities of individual RESS modules 30-1, 30-2, 30-3 and auxiliary module 45 by prioritizing thermal conditioning thereof.

Generally, during regular operation of the RESS 24, coolant flow through the coolant branches 44-1, 44-2, 44-3 is used to absorb thermal energy released by battery cells 28 in the individual battery modules 30-1, 30-2, 30-3 and stabilize RESS operation. During various extreme and/or transient conditions, RESS 24 modules and auxiliary systems and modules 45 may benefit from being thermally conditioned via controlling temperature of the coolant 40. However, under certain conditions, physical and thermal characteristics of RESS modules 30-1, 30-2, 30-3 may interfere with operating requirements of the HVAC system 26.

For example, during cold start and warm up of the vehicle 10, RESS 24 modules may benefit from additional thermal energy to generate requisite power output for vehicle propulsion. Simultaneously, the HVAC system 26 may be requested to provide heat to the vehicle cabin 10A. To satisfy the above requirements, the heater 56-3 may be directed to add thermal energy to the coolant 40. Optimal temperature ranges for the two systems in those conditions, however, will likely not be the same. As both the RESS 24 and the HVAC system 26 receive thermal conditioning from the same body of coolant 40, RESS modules, having a higher thermal mass than the auxiliary module(s) 45, will continue absorbing thermal energy from the coolant 40 past the point where one or more RESS modules are within acceptable temperature range.

Accordingly, RESS module(s) will absorb energy that would be of greater benefit to the HVAC system 26 and thus delay cabin warm-up. Similarly, when vehicle 10 is operating in a hot environment, the coolant-to-air heat exchanger 56-2 may be directed to remove thermal energy from the coolant 40. The RESS modules will continue rejecting thermal energy into the coolant 40 even if one or more modules are within their acceptable temperature range. Because each RESS module has a higher thermal mass than at least one of the auxiliary modules 45, if the RESS 24 and HVAC system 26 continue to receive coolant from the main loop 38, the HVAC system will be able to reject less heat to the coolant 40 due to the competing rejection of heat by the RESS modules, and thus delay cabin cool-down.

As shown in FIG. 1, vehicle 10 also includes a system 62 for prioritizing, enhancing, and optimizing performance capabilities of associated RESS and auxiliary modules by prioritizing thermal conditioning thereof. The electronic controller 58 is programmed with particular algorithm(s) 60 to operate the subject system. Specifically, the algorithm(s) 60 include an inventory mode configured to monitor temperatures of the RESS modules 30-1, 30-2, 30-3 and the auxiliary module(s) 45, such as via respective RESS temperature sensor(s) 64-1, 64-2, 64-3 and auxiliary temperature sensor 64-4. The electronic controller 58 is programmed to determine when the temperature of at least one of the RESS modules 30-1, 30-2, 30-3 is inside a first predetermined temperature range 66-1. The first predetermined temperature range 66-1 for batteries may be from -20 to +50 degrees Celsius.

The electronic controller 58 is also programmed to determine when temperature of a particular auxiliary module 45, such as the BDU, APM, OBCM, or coolant bypass, is outside a second predetermined temperature range 66-2. The second predetermined temperature range 66-2 for BDU, APM, OBCM auxiliary modules may be from -35 to +70 degrees Celsius. For cold environment operation (e.g., -10 degrees Celsius ambient environment 34), the coolant 40 may be passed through the coolant heater 56-3 to increase coolant temperature above ~5 degrees Celsius for HVAC system 26 heating mode. For hot operation (e.g., 35 degrees Celsius ambient environment 34), the coolant 40 may be passed through the coolant-to-air heat exchanger 56-2 to reduce coolant temperature below ~40 degrees Celsius for HVAC system 26 cooling mode. The electronic controller 58 is also programmed to thermally condition the coolant 40 (increase or decrease temperature thereof) in the main coolant loop 38 to a target temperature 68, using the appropriate coolant thermal conditioning device 56-2 or 56-3.

The electronic controller 58 is additionally programmed to restrict, i.e., throttle or shut off, a flow of coolant 40 (via appropriate RESS flow-valve(s) 50) from the main coolant loop 38 individually into at least one of the RESS coolant branches 44-1, 44-2, 44-3 when temperature of the corresponding RESS module(s) is inside the first predetermined temperature range 66-1. Such restriction of the flow of coolant 40 through the respective RESS module(s) 30-1, 30-2, 30-3 would maintain a larger volumetric flow rate of coolant through the auxiliary module(s) 45 and limit the subject RESS module(s) influence on the temperature of coolant in the cooling subsystem 36. The electronic controller 58 is further programmed to regulate a flow of coolant 40 from the main coolant loop 38 into the auxiliary coolant branch 44-4, when temperature of the auxiliary module 45, e.g., the HVAC, is outside the second predetermined temperature range 66-2.

By restricting flow through RESS module(s) 30-1, 30-2, 30-3, more coolant 40 would be routed through the auxiliary module(s) 45. The flow of coolant 40 may be regulated to at least a predefined minimum volumetric flow rate for requisite HVAC 26 performance by allowing more volumetric flow through auxiliary coolant branch 44-4. Additionally, the coolant flow rate may be further increased through the auxiliary module(s) 45, if the auxiliary module(s) are outside the second predetermined temperature range 66-2. After the coolant 40 has passed through the auxiliary branch 44-4, the electronic controller 58 may regulate the coolant to pass through the HVAC heat exchanger 56-1 to provide the target temperature coolant from the main coolant loop to the HVAC to thermally condition the HVAC system 26 to either heat up or cool down the cabin 10A. The net result of such prioritized thermal conditioning is enhanced performance of the HVAC system 26, such as increased HVAC heat output during vehicle 10 cold start or reduced heat soak for cooler cabin air during hot ambient conditions.

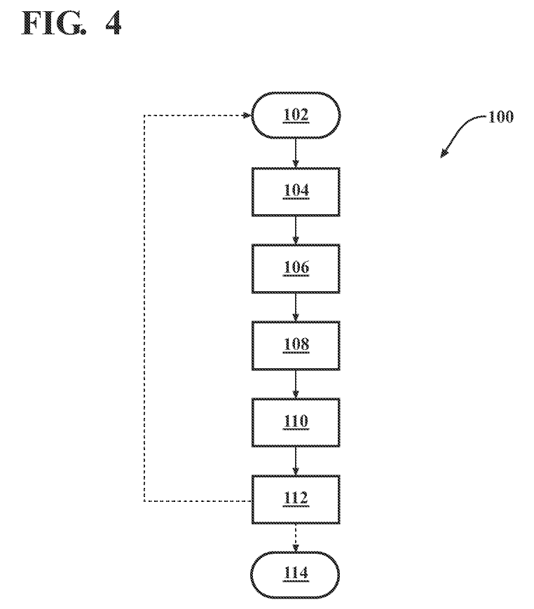

A method 100 of prioritizing, enhancing, and optimizing performance of the HVAC system 26 thermally conditioned by the multiple branch cooling subsystem 36 is shown in FIG. 4 and described below with reference to the structure shown in FIGS. 1-3. Method 100 commences in frame 102 with monitoring, via the electronic controller 58, the temperatures of the RESS modules 30-1, 30-2, 30-3 and the auxiliary module(s) 45, such as via respective RESS temperature sensor(s) 64-1, 64-2, 64-3 and auxiliary temperature sensor 64-4 and may also monitor temperature in the vehicle cabin 10A and the ambient environment 34. In frame 102, the method may additionally include detecting, via electronic controller 58, an operator request to start the vehicle 10, e.g., a key-on mode of the powertrain 12, for the RESS 24 to start discharging power. After frame 102, the method proceeds to frame 104.

In frame 104, the method includes determining, via the electronic controller 58, when the temperature of the RESS module(s) 30-1, 30-2, 30-3 is inside the first predetermined temperature range 66-1. Following frame 104, the method advances to frame 106. In frame 106, the method includes determining, via the electronic controller 58, when the temperature of a particular auxiliary module 45 is outside a second predetermined temperature range 66-2. Following completion of frame 106, the method moves on to frame 108. In frame 108, the method includes thermally conditioning, via the electronic controller 58 (using either the coolant-to-air heat exchanger 56-2 or the heater 56-3), the coolant in the main coolant loop 38 to a target temperature 68. Such thermal conditioning may, for example, include increasing temperature of coolant 40 above the predetermined value 68 for heating the vehicle cabin 10A via the HVAC system 26 following a vehicle cold start. After frame 108, the method proceeds to frame 110.

In frame 110, the method includes restricting, via the electronic controller 58, the flow of coolant 40 (via RESS flow-valve(s) 50) from the main coolant loop 38 individually into at least one of the RESS coolant branches 30-1, 30-2, 30-3 when temperature of the corresponding RESS module(s) is inside the first predetermined temperature range 66-1. Such restricting of the flow of coolant 40 into RESS coolant branch(s) 30-1, 30-2, 30-3 is intended to maintain a larger volumetric flow rate of coolant through auxiliary module(s) 45 and limit the subject RESS module(s) influence on the temperature of coolant in the cooling subsystem 36. After frame 110, the method proceeds to frame 112. In frame 112, the method includes regulating, via the electronic controller 58, the flow of coolant 40 from the main coolant loop 38 into the particular auxiliary coolant branch 44-4 when temperature of the corresponding auxiliary module 45 is outside the second predetermined temperature range 66-2.

Additionally, in frame 112, the flow of coolant 40 through the HVAC heat exchanger 56-1 may be regulated to provide at least a predefined minimum volumetric flow rate for requisite HVAC 26 performance by allowing more volumetric flow through auxiliary coolant branch(s) 44-4. For cold system 62 operation, after passing the coolant 40 through the auxiliary branch 44-4, the electronic controller 58 may regulate the coolant to pass through the coolant heater 56-3 and regulate coolant temperature to be above ~5 degrees Celsius for HVAC system 26 heating mode. For hot system 62 operation, after passing the coolant 40 through the auxiliary branch 44-4, the electronic controller 58 may regulate the coolant to pass through the coolant-to-air heat exchanger 56-2 and regulate coolant temperature to be less than ~40 degrees Celsius for HVAC system 26 cooling mode. The intended result of regulating the flow of coolant 40 into the subject auxiliary coolant branch 44-4 is to enhance performance of the HVAC system 26.

Following frame 112, the method may loop back to frame 102 for continued monitoring of the respective RESS and auxiliary module temperatures. If the various monitored temperatures have equalized or determined to have reached predefined steady state or acceptable limit conditions, the method may conclude in frame 114. Alternatively, if the powertrain 12 and other vehicle systems, such as the auxiliary module(s) 45 have been switched off, and the fluid pump 42 has been deactivated, the method may shut down current flow and power generation in the RESS 24 and similarly conclude in frame 114. Overall, method 100 uses the flexibility afforded by individually controlled parallel coolant branches of the cooling subsystem 36 to enhance the performance of HVAC system 26 using a shared coolant supply with the RESS 24 and the auxiliary module(s) 45.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework and the scope of the appended claims.

What is claimed is:

1. A system for enhancing performance capabilities of a heating, air conditioning, and ventilation (HVAC) system, comprising:
a multi-cell rechargeable energy storage system (RESS) having a plurality of relatively high thermal mass RESS modules;
an auxiliary module having a relatively low thermal mass;
a cooling subsystem including:
a main coolant loop fluidly connected to the HVAC system and configured to circulate coolant;
at least one coolant thermal conditioning device arranged in the main coolant loop;
a plurality of RESS coolant branches arranged in parallel, wherein each RESS coolant branch is configured to receive coolant from the main coolant loop to adjust temperature of one of the respective RESS modules; and
an auxiliary coolant branch arranged in parallel with the plurality of RESS coolant branches and configured to receive coolant from the main coolant loop to adjust temperature of the auxiliary module; and
an electronic controller in operative communication with the cooling subsystem and configured to:
determine when temperature of at least one of the RESS modules is inside a first predetermined temperature range;
determine when temperature of the auxiliary module is outside a second predetermined temperature range;
thermally condition the coolant in the main coolant loop to a target temperature;
restrict a flow of coolant, from the main coolant loop individually into at least one of the RESS coolant branches when temperature of the corresponding at least one RESS module is inside the first predetermined temperature range; and
regulate a flow of coolant from the main coolant loop into the auxiliary coolant branch when temperature of the auxiliary module is outside the second predetermined temperature range to provide the coolant at the target temperature from the main coolant loop to the HVAC system.

2. The system according to claim 1, wherein the relatively high thermal mass RESS modules include individual battery modules having a plurality of battery cells.

3. The system according to claim 1, wherein the cooling subsystem additionally includes at least one RESS flow-valve in operative communication with the electronic controller and configured to regulate and distribute across the plurality of RESS coolant branches the coolant received from the main coolant loop.

4. The system according to claim 3, wherein the at least one RESS flow-valve is a multi-way valve assembly arranged in a junction between the main coolant loop and the plurality of RESS coolant branches and configured to control a flow of the coolant into each of the RESS coolant branches.

5. The system according to claim 3, wherein the at least one RESS flow-valve is a plurality of individual throttle valves, each throttle valve arranged in one of the plurality of RESS coolant branches upstream of the corresponding RESS module and configured to control a flow of the coolant into the subject RESS coolant branch.

6. The system according to claim 1, wherein each RESS coolant branch includes a one-way valve configured to control a flow of the coolant out of the subject RESS coolant branch.

7. The system according to claim 1, wherein the cooling subsystem additionally includes a bypass flow-valve in operative communication with the electronic controller and configured to regulate the coolant in the auxiliary coolant branch and a one-way valve configured to control a flow of the coolant out of the auxiliary coolant branch.

8. The system according to claim 1, wherein the cooling subsystem additionally includes a one-way valve configured to control a flow of the coolant out of the auxiliary coolant branch.

9. The system according to claim 1, wherein the cooling subsystem additionally includes a fluid pump configured to circulate the coolant through the main coolant loop.

10. The system according to claim 1, wherein the at least one coolant thermal conditioning device includes a coolant heater configured to add thermal energy to the coolant in the main coolant loop and/or a coolant-to-air heat exchanger configured to remove thermal energy from the coolant in the main coolant loop.

11. A motor vehicle comprising:
an electric motor-generator configured to generate torque;
a heating, air conditioning, and ventilation (HVAC) system;
a multi-cell rechargeable energy storage system (RESS) configured to supply electrical energy to the electric motor-generator and having a plurality of relatively high thermal mass RESS modules;
an auxiliary module having a relatively low thermal mass;
a cooling subsystem including:
a main coolant loop configured to circulate coolant;
at least one coolant thermal conditioning device arranged in the main coolant loop;
a plurality of RESS coolant branches arranged in parallel, wherein each RESS coolant branch is configured to receive coolant from the main coolant loop to adjust temperature of one of the respective RESS modules; and
an auxiliary coolant branch arranged in parallel with the plurality of RESS coolant branches and configured to receive coolant from the main coolant loop; and
an electronic controller in operative communication with the cooling subsystem and configured to:
determine when temperature of at least one of the RESS modules is inside a first predetermined temperature range;
determine when temperature of the auxiliary module is outside a second predetermined temperature range;
thermally condition the coolant in the main coolant loop to a target temperature;
restrict a flow of coolant, from the main coolant loop individually into at least one of the RESS coolant branches when temperature of the corresponding at least one RESS module is inside the first predetermined temperature range; and
regulate a flow of coolant from the main coolant loop into the auxiliary coolant branch when temperature of the auxiliary module is outside the second predetermined temperature range to provide the coolant at the target temperature from the main coolant loop to the HVAC system.

12. The motor vehicle according to claim 11, wherein the relatively high thermal mass RESS modules include individual battery modules having a plurality of battery cells.

13. The motor vehicle according to claim 11, wherein the cooling subsystem additionally includes at least one RESS flow-valve in operative communication with the electronic controller and configured to regulate and distribute across the plurality of RESS coolant branches the coolant received from the main coolant loop.

14. The motor vehicle according to claim 13, wherein the at least one RESS flow-valve is a multi-way valve assembly arranged in a junction between the main coolant loop and the plurality of RESS coolant branches and configured to control a flow of the coolant into each of the RESS coolant branches.

15. The motor vehicle according to claim 13, wherein the at least one RESS flow-valve is a plurality of individual throttle valves, each throttle valve arranged in one of the plurality of RESS coolant branches upstream of the corresponding RESS module and configured to control a flow of the coolant into the subject RESS coolant branch.

16. The motor vehicle according to claim 11, wherein each RESS coolant branch includes a one-way valve configured to control a flow of the coolant out of the subject RESS coolant branch.

17. The motor vehicle according to claim 11, wherein the cooling subsystem additionally includes a bypass flow-valve in operative communication with the electronic controller and configured to regulate the coolant in the auxiliary coolant branch and a one-way valve configured to control a flow of the coolant out of the auxiliary coolant branch.

18. The motor vehicle according to claim 11, wherein the cooling subsystem additionally includes a one-way valve configured to control a flow of the coolant out of the auxiliary coolant branch.

19. The motor vehicle according to claim 11, wherein the at least one coolant thermal conditioning device includes a coolant heater configured to add thermal energy to the coolant in the main coolant loop and/or a coolant-to-air heat exchanger configured to remove thermal energy from the coolant in the main coolant loop.

20. A system for enhancing performance capabilities of a heating, air conditioning, and ventilation (HVAC) system, comprising:
a multi-cell rechargeable energy storage system (RESS) having a plurality of battery cells arranged in relatively high thermal mass individual battery modules;
an auxiliary module having a relatively low thermal mass;
a cooling subsystem including:
a main coolant loop fluidly connected to the HVAC system and configured to circulate coolant;
at least one coolant thermal conditioning device arranged in the main coolant loop;
a plurality of RESS coolant branches arranged in parallel, wherein each RESS coolant branch is configured to receive coolant from the main coolant loop to adjust temperature of one of the respective battery modules;
at least one RESS flow-valve configured to regulate and distribute across the plurality of RESS coolant branches the coolant received from the main coolant loop;
an auxiliary coolant branch arranged in parallel with the plurality of RESS coolant branches and configured to receive coolant from the main coolant loop to adjust temperature of the auxiliary module; and
a bypass flow-valve configured to regulate the coolant in the auxiliary coolant branch; and
an electronic controller in operative communication with the cooling subsystem and configured to:
determine when temperature of at least one of the battery modules is inside a first predetermined temperature range;
determine when temperature of the auxiliary module is outside a second predetermined temperature range;
thermally condition, via the at least one coolant thermal conditioning device, the coolant in the main coolant loop to a target temperature;
restrict a flow of coolant, via the at least one RESS flow-valve, from the main coolant loop individually into at least one of the RESS coolant branches when temperature of the corresponding at least one RESS module is inside the first predetermined temperature range; and
regulate a flow of coolant, via the bypass flow-valve, from the main coolant loop into the auxiliary coolant branch and provide at least a predefined minimum flow rate of the coolant through the cooling subsystem when temperature of the auxiliary module is outside the second predetermined temperature range to provide the coolant at the target temperature from the main coolant loop to the HVAC system.
